(19) United States
(12) Patent Application Publication
(10) Pub. No.: US 2012/0154628 A1
(43) Pub. Date: Jun. 21, 2012

(54) IMAGING DEVICE AND METHOD

(75) Inventor: Satoshi HORIUCHI, Yokohama-shi (JP)

(73) Assignee: Samsung Electronics Co., Ltd., Suwon-si (KR)

(21) Appl. No.: 13/328,449

(22) Filed: Dec. 16, 2011

(30) Foreign Application Priority Data
Dec. 20, 2010 (JP) 283825/2010
Dec. 8, 2011 (JP) 10-2011-0130754

(51) Int. Cl. H04N 9/73

(52) U.S. Cl. 348/226.1; 348/E09.051

(57) ABSTRACT

An imaging device and method, wherein the imaging device includes an exposure controller for setting a first electric-charge accumulation time for a first scanning line of an imaging element, and for setting a second electric-charge accumulation time for a second scanning line of the imaging element; a luminance difference calculator for calculating a luminance difference in a vertical direction between a first image signal based on the first scanning line and a second image signal based on the second scanning line from a frame output from the imaging element, the vertical direction being perpendicular to a direction of the scanning lines; and a flicker detector for determining whether flicker is generated in the frame based on the luminance difference.

### PRIORITY

This application claims priority under 35 U.S.C. §119(a) to Japanese Patent Application Serial No. JP 283825/2010, which was filed in the Japan Patent Office on Dec. 20, 2010, and Korean Patent Application Serial No. 10-2011-0130754, which was filed in the Korean Patent Office on Dec. 8, 2011, the entire disclosure of each of which is hereby incorporated by reference.

### BACKGROUND OF THE INVENTION

1. Field of the Invention

The present invention relates generally to an image device and an imaging method, and more particularly, to an imaging device and method that provide an auto exposure function.

2. Description of the Related Art

When an image is captured using an electronic imaging device, such as a digital camera, in an indoor environment, e.g., under fluorescent illumination, the illuminance of an object periodically changes, causing luminance noise in the captured image. Herein, a periodic change in the illuminance will be referred to as a “flicker,” and the luminance noise generated in the image by the flicker will be referred to as “flicker noise.” Examples of flicker noise include a luminance difference generated between consecutive frames of a moving image, and a striped pattern generated in an image.

Japanese Patent Publication No. 2006-121605 discloses a technique for detecting a flicker by using an index derived from a differential with respect to a luminance average of each of a plurality of frame images captured during a predetermined period. Further, Japanese Patent No. 3823314 proposes a technique for estimating a flicker frequency by measuring a peak and a valley of a flicker component extracted as a luminance difference between two executive frames with the use of a flicker detection frame which is set in an image, and Japanese Patent Publication No. 2010-520673 discloses a technique for extracting a flicker component based on a luminance difference between an image captured during an exposure time synchronized with a flicker period and an image captured during each of the other exposure times in a Complementary Metal-Oxide Semiconductor (CMOS) sensor.

However, these conventional techniques detect a flicker by observing a luminance change between a plurality of frames. However, if image shake occurs between frames, for example, while photographing a moving object, then the precision of flicker detection is degraded.

### SUMMARY OF THE INVENTION

The present invention has been made to solve at least the above-described problems occurring in the prior art, and to provide at leas the advantages described below.

Accordingly, an aspect of the present invention is to provide an imaging device and an imaging method for detecting a flicker with high precision using a single-frame image.

In accordance with an aspect of the present invention, an imaging device is provided, which includes an exposure controller for setting a first electric-charge accumulation time for a first scanning line of an imaging element, and for setting a second electric-charge accumulation time for a second scanning line of the imaging element; a luminance difference calculator for calculating a luminance difference in a vertical direction between a first image signal based on the first scanning line and a second image signal based on the second scanning line from a frame output from the imaging element, the vertical direction being perpendicular to a direction of the scanning lines; and a flicker detector for determining whether flicker is generated in the frame based on the luminance difference.

In accordance with another aspect of the present invention, an imaging method is provided, which includes setting a first electric-charge accumulation time for a first scanning line of an imaging element, setting a second electric-charge accumulation time for a second scanning line of the imaging element, calculating a luminance difference in a vertical direction between a first image signal based on the first scanning line and a second image signal based on the second scanning line of a frame output from the imaging element, the vertical direction being perpendicular to a direction of the scanning lines, and determining whether flicker is generated in the frame based on the luminance difference.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a graph illustrating a voltage change in Alternating-Current (AC) power;

FIG. 2 is a graph illustrating luminance of a light source;

FIG. 3 illustrates a surface flicker when using a Charge Coupled Device (CCD) as an imaging element;

FIG. 4 illustrates a line flicker when using a Complementary Metal-Oxide Semiconductor (CMOS) as an imaging element;

FIG. 5 is a graph illustrating a generation of a surface flicker;

FIG. 6 is a diagram illustrating a generation of a line flicker;

FIG. 7 is a diagram illustrating a scenario in which a surface flicker is not generated;

FIG. 8 is a graph illustrating a scenario in which a line flicker is not generated;

FIG. 9 illustrates an example of a related conventional technique for detecting a surface flicker;

FIG. 10 illustrates an example of a related conventional technique for detecting a line flicker;

FIG. 11 illustrates a field configuration of an imaging element according to an embodiment of the present invention;

FIG. 12 is a block diagram illustrating an imaging device according to an embodiment of the present invention;

FIG. 13 is a flowchart illustrating an imaging method according to an embodiment of the present invention;

FIG. 14 illustrates flicker noise that may be generated in accordance with an embodiment of the present invention;

FIG. 15 illustrates color channel separation in accordance with an embodiment of the present invention; and

FIG. 16 illustrates a calculation of a luminance change difference in accordance with an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In the specification and drawings, components having substantially like functions will be referred to with reference numerals to avoid repetitive descriptions.

As described above, flicker refers to a periodic change in the illuminance of an object. For example, the change in the illuminance of an object may be caused by a change in the illuminance of a light source, which may be caused by a voltage change in power supplied to the light source.

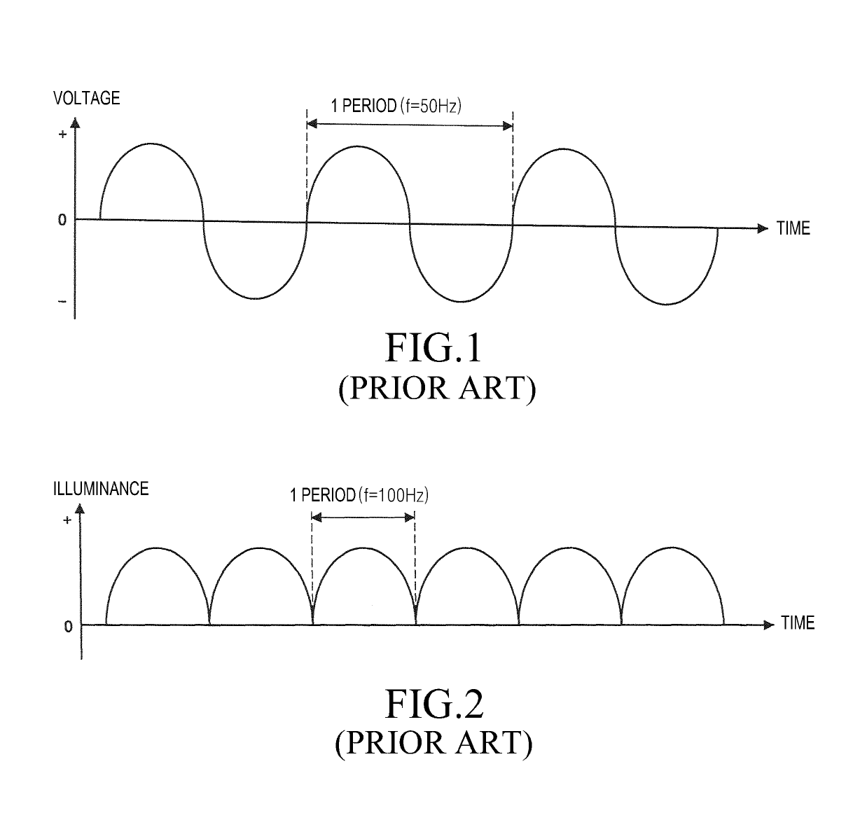

FIG. 1 is a graph illustrating an example of a voltage change in Alternating-Current (AC) power.

Referring to FIG. 1, the voltage change in the AC power is represented by a sine wave. The frequency of general AC power is 50 Hz or 60 Hz, such that the power voltage change in the AC power is a sine wave having a frequency f=50 Hz or a sine wave having a frequency f=60 Hz. The example illustrated in FIG. 1 is the sine wave having a frequency f=50 Hz.

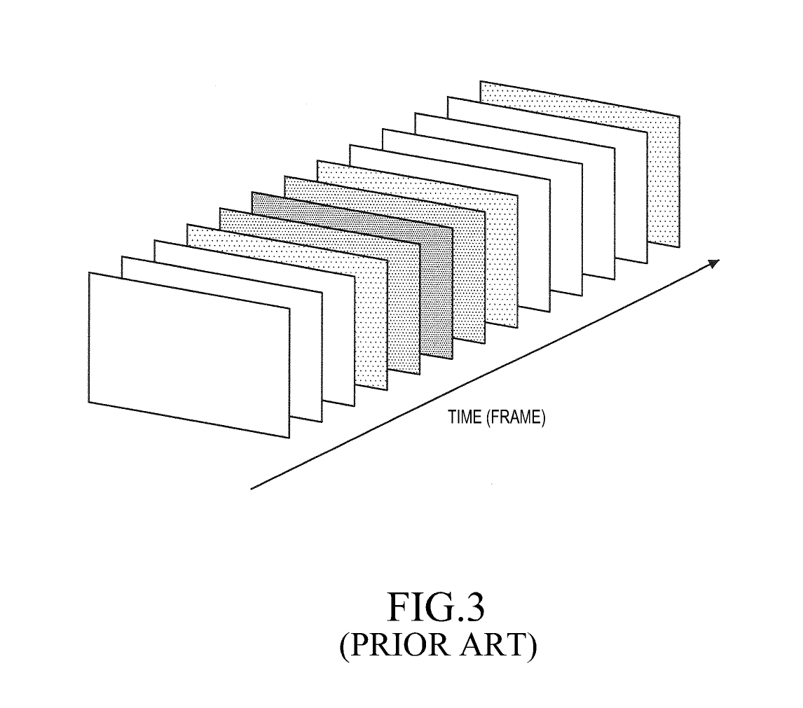

FIG. 2 is a graph illustrating luminance of a light source.

Referring to FIG. 2, luminance (that is, brightness) of a light source provided with an AC power changes at a frequency that is two times that of the AC power. As described above, the frequency of general AC power is 50 Hz or 60 Hz, and the frequency of the illuminance of the light source is two times that of the AC power, such that the frequency of the illuminance of the light source may be f=100 Hz or f=120 Hz. The example illustrated in FIG. 2 corresponds to 50 Hz AC power, such that illuminance of the light source changes at the frequency f=100 Hz.

Flicker is caused by a light source whose illuminance periodically changes, as in the example illustrated in FIG. 2. Hereinafter, such a light source will be referred to as a “flicker light source.”

The luminance of an object periodically changes with the illuminance of the flicker light source, such that flicker frequency becomes the same as the frequency of the illuminance change of the flicker light source. Thus, when general AC power is used as a power of the light source, the flicker frequency is either 100 Hz or 120 Hz. Herein, a flicker having a flicker frequency of 100 Hz will be referred to as a “100 Hz flicker” and a flicker having a flicker frequency of 120 Hz will be referred to as a “120 Hz flicker.”

Table 1 below shows a type of an imaging element, i.e., a CCD or a CMOS, in which a flicker noise may be generated with respect to a type of flicker noise, i.e., surface flicker or line flicker, and a summary of flicker noise.

TABLE 1

| Type of | | |
|---|---|---|
| Flicker | Type of Imaging | |
| Noise | Element | Summary |
| Surface | CCD | For a CCD, an average luminance of a frame |
| Flicker | | periodically changes while capturing of a |
| | | moving image. |
| Line | CMOS | While capturing a still image using a rolling- |
| Flicker | | shutter scheme, a horizontal striped pattern |
| | | is generated. |

An imaging element includes a plurality of pixel units arranged in an M×N matrix form, and the pixel units may include a photodiode and a plurality of transistors. A pixel unit accumulates an electric charge generated by incident light, and a voltage produced from the accumulated charge indicates the illuminance of the incident light. When an image forming a still image or a moving image is processed, an image signal output from the imaging element includes a group of voltages (i.e., pixel values) output from the pixel units, and the image signal indicates a single frame (i.e., a still image). The single frame is composed of M×N pixels.

FIG. 3 illustrates a surface flicker when using a CCD as the imaging element.

Referring to FIG. 3, if a surface flicker is generated when using a CCD as the imaging element, an average luminance (i.e., an average brightness) of consecutive frames periodically changes. In FIG. 3, a luminance of a square frame is indicated by the intensity of dots, and as the luminance of the frame decreases, the intensity of dots increases. The exposure timings of the pixel units forming the imaging element match one another.

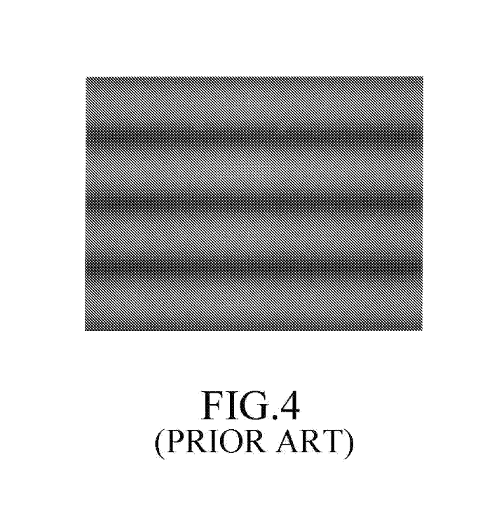

FIG. 4 illustrates a line flicker when using a CMOS as the imaging element.

Referring to FIG. 4, when using a CMOS as the imaging element, upon generation of a line flicker, the luminance of an image changes in a vertical direction, resulting in a horizontal striped pattern. The exposure timings of pixel unit rows (i.e., scanning lines) forming the imaging element are different from one another. In other words, the exposure timings of N pixel units included in one of M scanning lines match one another, but the exposure timing of, for example, a first scanning line is faster than that of a second scanning line.

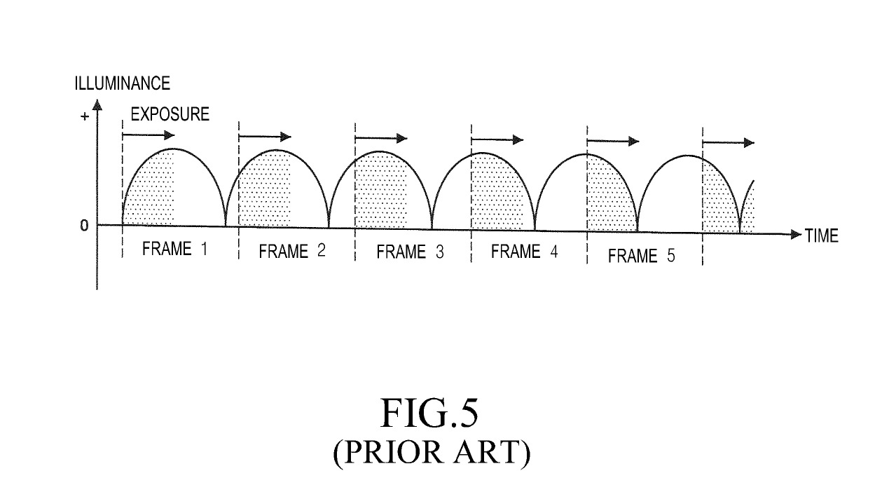

FIG. 5 is a graph illustrating a generation of a surface flicker.

Referring to FIG. 5, the surface flicker is caused by different illuminance phases of an object during capturing of respective frames. When the illuminance of the object periodically changes, the phase change of the illuminance varies in exposure time ranges of the respective frames indicated by arrows. Therefore, except for special cases, which will be described below, a light exposure, i.e., an illuminance integral value during an exposure time, varies from frame to frame. As a result, an average luminance of each frame periodically changes, causing the surface flicker.

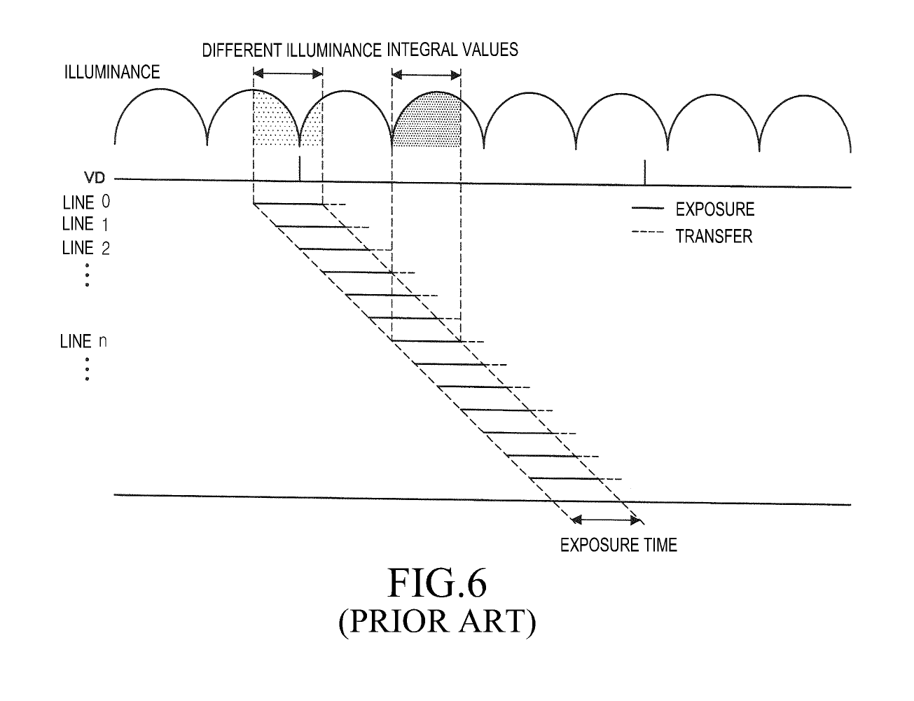

FIG. 6 is a diagram illustrating generation of a line flicker.

Referring to FIG. 6, the line flicker is generated because an exposure timing differs from scanning line to scanning line when the image element is a CMOS of a rolling shutter type. When the illuminance of an object periodically changes, the phase change of the illuminance varies in an exposure time range of each scanning line sequentially exposed in the rolling shutter operation. Therefore, except for a special case, which will be described below, an illuminance integral value during an exposure time differs from scanning line to scanning line. As a result, the luminance of each scanning line periodically changes, causing the line flicker in the image. In the example illustrated in FIG. 6, an illuminance integral value in an exposure timing differs among lines 0 through n.

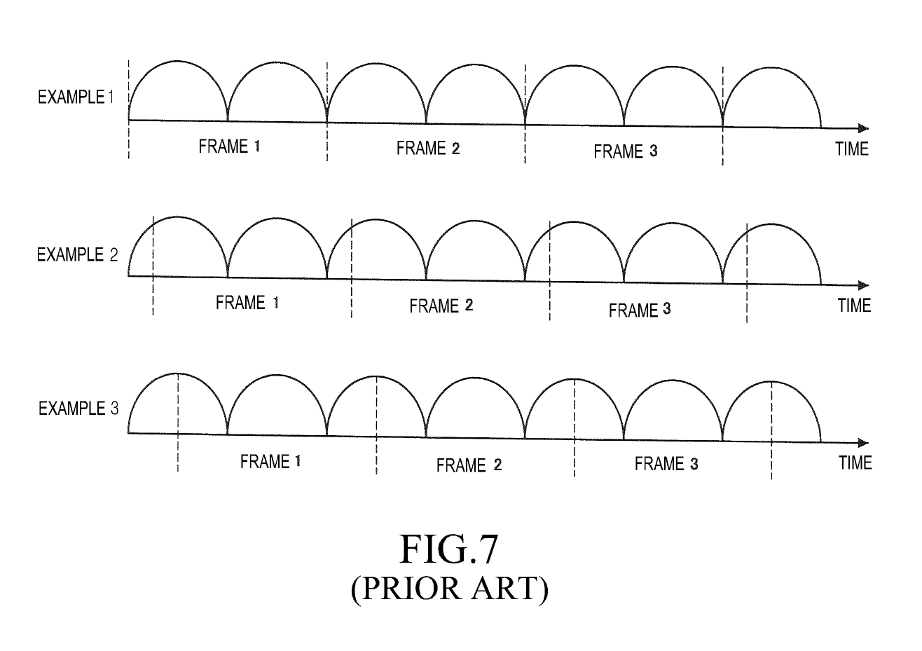

FIG. 7 is a diagram illustrating scenario in which surface flicker is not generated.

Referring to FIG. 7, in Examples 1 through 3, if a frame interval between moving image capturing operations is a natural-number multiple of (e.g., n times) an illuminance change period of an object (where n is a natural number), the surface flicker is not generated. In this case, the phase change of the illuminance in an exposure time range of each frame is identical across the frames. Therefore, the illuminance integral value in an exposure time is identical across the frames, and as a result, the surface flicker is not generated. However, in this case, the line flicker may still be generated. If the frame interval is a natural-number multiple of the illuminance change period of the object, a frame rate, which is a reciprocal of the frame interval, is 1/n of a frequency, which is a reciprocal of the illuminance change period of the object, where n is a natural number. Hereinafter, this scenario will be referred to as the frame rate being synchronized with the flicker frequency.

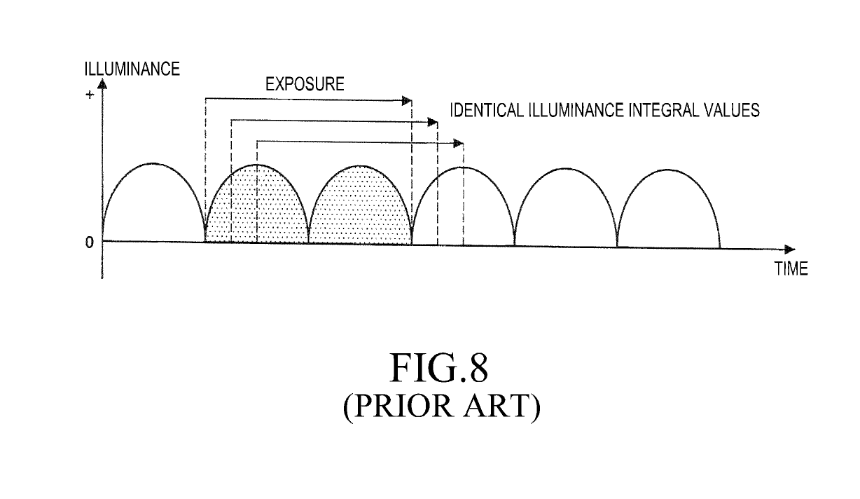

FIG. 8 is a graph illustrating a scenario in which line flicker is not generated.

Referring to FIG. 8, if an exposure time is a natural-number multiple of the illuminance change period of the object, the line flicker is not generated. In this case, the phase change of the illuminance in an exposure time range differs from scanning line to scanning line, but an illuminance integral value in an exposure time is identical across the scanning lines. As a result, the line flicker is not generated. In this case, an illuminance integral value in an exposure time range is identical across the plurality of frames, such that the surface flicker is not generated, either. Where the exposure time is the natural-number multiple of the illuminance change period of the object will be referred to as herein as the exposure time being synchronized with the flicker period.

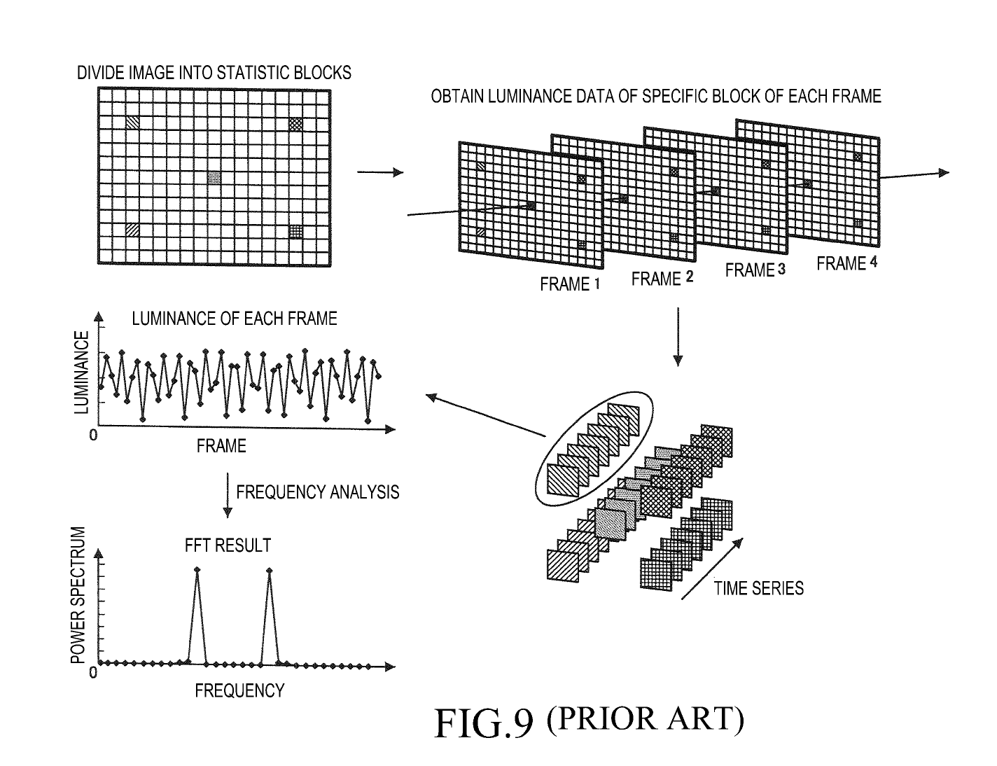

FIG. 9 is a diagram illustrates a related conventional technique for detecting a surface flicker. Specifically, the related conventional technique for detecting the surface flicker estimates the flicker frequency by performing frequency analysis on an average luminance of the entire image or a specific portion in a plurality of frames.

Referring to FIG. 9, first, each frame image is divided into statistic blocks of a predetermined size. Next, a plurality of specific blocks (specific portions) are set among the statistic blocks of each frame. Then, for each specific block, luminance data is obtained for a plurality of consecutive frames. A luminance change obtained among the plurality of frames in each specific block is frequency-analyzed by, for example, Fast Fourier Transform (FFT). Accordingly, a power spectrum indicating the flicker frequency is obtained, and generation/non-generation of the surface flicker and the frequency of the flicker are specified.

However, for frequency-analysis with respect to the luminance change among the plurality of frames, many frames have to be analyzed. For example, in the example illustrated in FIG. 9, when the frequency analysis is carried out using FFT, at least 16 frames need to be analyzed.

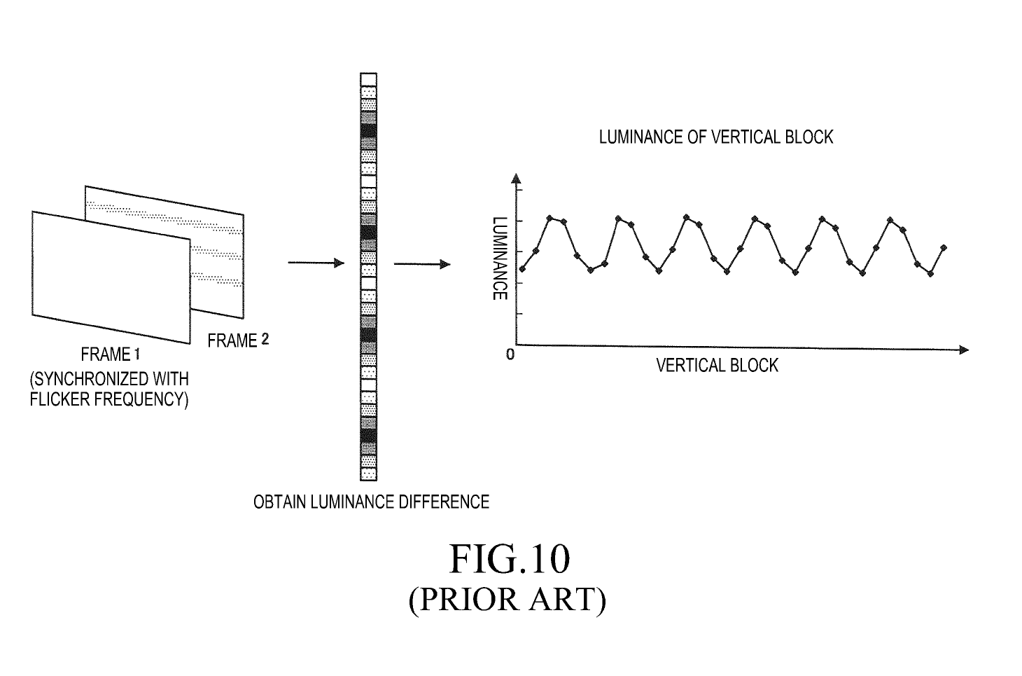

FIG. 10 illustrates a related conventional technique for detecting a line flicker.

Specifically, the related conventional technique for detecting a line flicker estimates generation/non-generation of the line flicker from a luminance difference between a plurality of frame images having different exposure times.

Referring to FIG. 10, a luminance difference between a first frame having an exposure time of 1/100 sec and a second frame having an exposure time of 1/90 sec is obtained. Further, it is assumed that the illuminance of a light source periodically changes at a frequency f=100 Hz, as described above with reference to FIG. 2. In this case, in a frame 1 having an exposure time of 1/100 sec, as described above with reference to FIG. 8, the exposure time is synchronized with a flicker period, such that an illuminance integral value during the exposure time is identical across scanning lines, resulting in non-generation of the line flicker.

In a frame 2 having an exposure time of 1/90 sec, the exposure time is not synchronized with the flicker period. Accordingly, the exposure time of the second frame is not synchronized with the flicker period, even when the illuminance of the light source periodically changes at a frequency f=120 Hz. In this case, in the frame 2, luminance periodically changes in each scanning line, resulting in generation of the line flicker in the image. By obtaining a luminance difference between consecutive blocks in a vertical direction between the frame 1 and the frame 2, a periodic luminance change is extracted as a flicker component.

However, the related conventional technique for detecting the line flicker also needs a plurality of frames for detection. Therefore, if image shake occurs between frames, for example, during photographing of an object having motion, then the precision of flicker detection may degrade.

In accordance with an embodiment of the present invention, by alternately setting a first electric-charge accumulation time and a second electric-charge accumulation time, which are different from each other, in consecutive scanning lines of an imaging element that obtains an image signal, a flicker is detected by a single-frame image, thereby preventing the precision of flicker detection from degrading due to the necessity of using the plurality of frames for flicker detection in the conventional techniques.

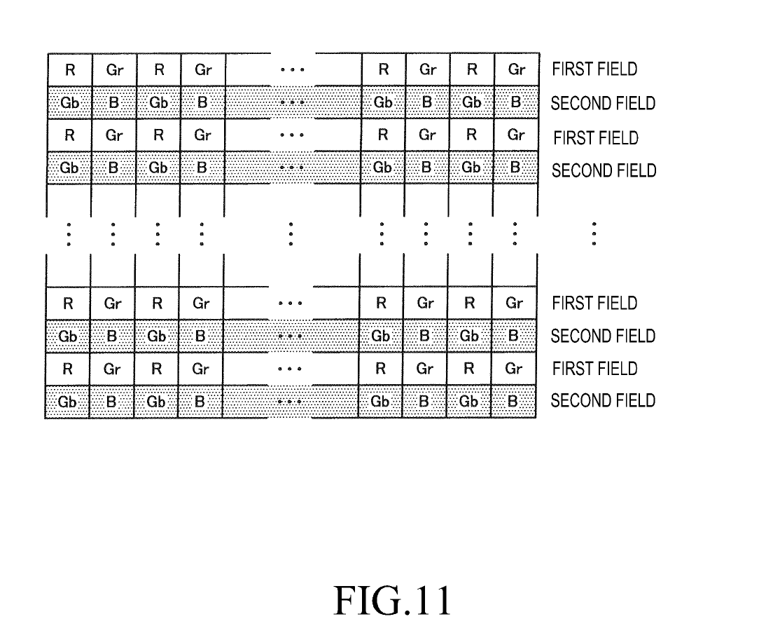

FIG. 11 illustrates a field configuration of an imaging element according to an embodiment of the present invention.

Referring to FIG. 11, in an imaging element having a Bayer Color Filter Array (CFA), respective scanning lines in the horizontal direction are alternately classified into a first field (i.e., a field or row of a first type, or a first scanning line) and a second field (i.e., a field or row of a second type, or a second scanning line). The Bayer CFA includes filter units of three colors (i.e., Red (R), Green (G), and Blue (B)) arranged in an M×N matrix form, and filter units of each color are arranged in each of the row direction and the column direction. The filter units one-to-one correspond to pixel units of the imaging element.

For example, light (or a channel) having passed through an R filter unit has the red color, and a pixel unit arranged to correspond to the R filter unit detects the red light. In FIG. 11, the first field is a scanning line having R (red) and Gr (green) pixel units and the second field is a scanning line having B (blue) and Gb (green) pixel units. Gr is a green pixel unit included in the same scanning line as R, i.e., the first field, and Gb is a green pixel unit included in the same scanning line as B, i.e., the second field.

In accordance with an embodiment of the present invention, a scanning line included in the first field and a scanning line included in the second field are captured during different electric-charge accumulation times (exposure times). Because the Gr pixel unit is included in the first field and the Gb pixel unit is included in the second field, they are captured in different electric-charge accumulation times. As such, by obtaining a luminance change difference (i.e., a luminance difference) between two color channels of Gr and Gb captured in different electric-charge accumulation times, a flicker component is extracted.

An exposure time difference between the first field and the second field is set such that a light-receiving sensitivity difference between two color channels of Gr and Gb is sufficiently smaller than a luminance difference generated by a flicker. In the current example, similar color channels are compared with each other to improve the accuracy of measurement, but different color channels may be compared or the entire first field and the entire second field may be compared with each other.

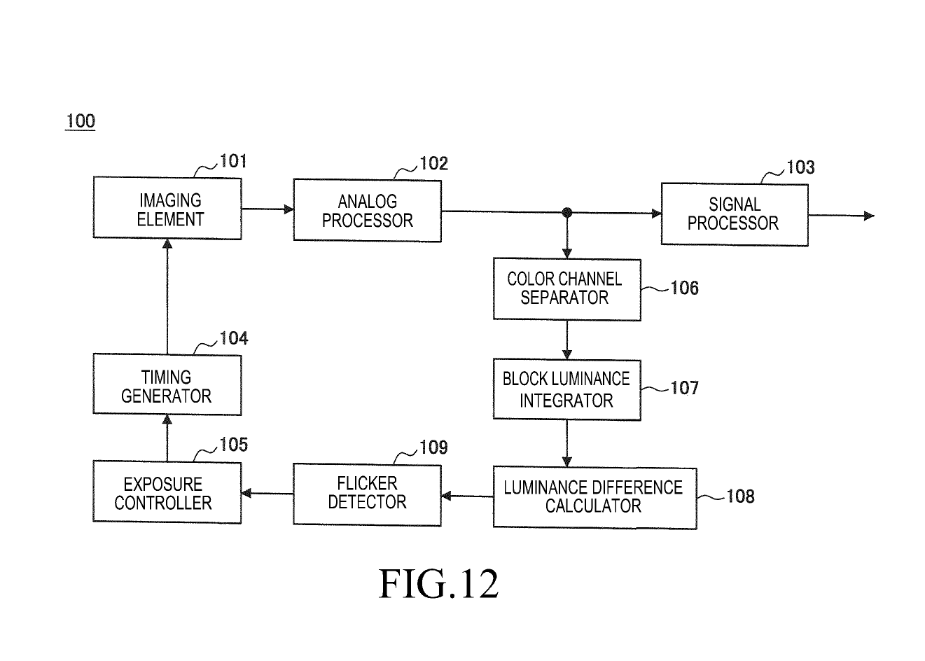

FIG. 12 is a block diagram illustrating an imaging device according to an embodiment of the present invention. The imaging device may be, for example, a compact digital camera, or other device having an imaging function, such as a video camera.

Referring to FIG. 12, the imaging device 100 includes an imaging element 101, an analog processor 102, a signal processor 103, a timing generator 104, an exposure controller 105, a color channel separator 106, a block luminance integrator 107, a luminance difference calculator 108, and a flicker detector 109. Each component, except for the imaging element 101, may be implemented using dedicated hardware as well as, for example, a Digital Signal Processor (DSP), and may also be implemented as software when a Central Processing Unit (CPU) operates based on a program stored in a memory device.

The imaging element (i.e., an image sensor) 101 outputs an image signal, which is generated by photo-electrically converting an optical image (object image) incident from an optical system, such as a lens (not shown), to the analog processor 102. The imaging element 101 may be, for example, a CMOS of a rolling shutter type. As described with reference to FIG. 11, the imaging element 101 uses a Bayer CFA and includes a plurality of scanning lines classified as the first field or the second field. The imaging element 101 outputs a first image signal based on scanning lines of the first field and a second image signal based on scanning lines of the second field to the analog processor 102 as the image signal.

The analog processor 102 processes the image signal input from the imaging element 101 to output RAW data including information of respective color channels R, Gr, Gb, and B to the signal processor 103 and the color channel separator 106. The analog processor 102 removes low-frequency noise included in an electric signal by using, for example, a Correlated Double Sampling (CDS) circuit, and amplifies the electric signal to an arbitrary level by using an amplifier (not shown).

Herein, the analog processor 102 may set an amplification gain of the amplifier for an image signal corresponding to each scanning line of the imaging element 101. If different electric-charge accumulation times are set between the scanning lines of the first field and the scanning lines of the second field by the exposure controller 105 to be described below, the analog processor 102 sets different amplification gains between the first image signal output from the scanning lines of the first field and the second image signal output from the scanning lines of the second field to compensate for a luminance difference caused by a difference between the electric-charge accumulation times.

The signal processor 103 performs analog-to-digital conversion on the RAW data input from the analog processor 102, thus obtaining a digital image signal including R, G, and B image signals. The signal processor 103 outputs the obtained image signals to store or display a captured image in the imaging device 100.

The timing generator 104 is controlled by the exposure controller 105, generates various pulses for driving the imaging element, and provides the generated pulses to the imaging element 101. For example, an electric-charge accumulation time of each scanning line included in the imaging element 101 is determined by a pulse provided by the timing generator 104.

The exposure controller 105 controls the timing generator 104 to set an electric-charge accumulation time of each scanning line of the imaging element 101. As described above, the scanning lines included in the imaging element 101 are classified as the first field or the second field. The exposure controller 105 may set different electric-charge accumulation times for respective scanning lines, and set the first electric-charge accumulation time or the second electric-charge accumulation time, which are different from each other, for the scanning lines included in the first field and the scanning lines included in the second field.

The color channel separator 106 separates the RAW data input from the analog processor 102 into color channel information of R, Gr, Gb, and B. The color channel separator 106 outputs image signals of color channels of at least Gr and Gb among image signals of the separated color channels to the block luminance integrator 107.

The block luminance integrator 107 obtains a luminance integral value in each of a plurality of blocks (i.e., a group of pixels) divided from an image by using the image signals input from the color channel separator 106, and outputs the luminance integral values to the luminance difference calculator 108. The block luminance integrator 107 calculates a luminance integral value for each block by using image signals of the color channels of at least Gr and Gb. In accordance with an embodiment of the present invention, a luminance integral value of the color channel of Gr corresponds to a luminance of the first image signal based on the scanning lines of the first field, and a luminance integral value of the color channel of Gb corresponds to a luminance of the second image signal based on the scanning lines of the second field.

The luminance difference calculator 108 calculates a difference between vertical-direction changes of luminance integral values (luminance changes) for each block input from the block luminance integrator 107, and outputs the difference to the flicker detector 109. Herein, the vertical direction is a direction perpendicular to the scanning line direction of the imaging element 101.

The flicker detector 109 determines whether a flicker is generated based on the luminance change difference input from the luminance difference calculator 108. The flicker detector 109 may specify the frequency of the flicker by performing frequency-analysis on the luminance change difference.

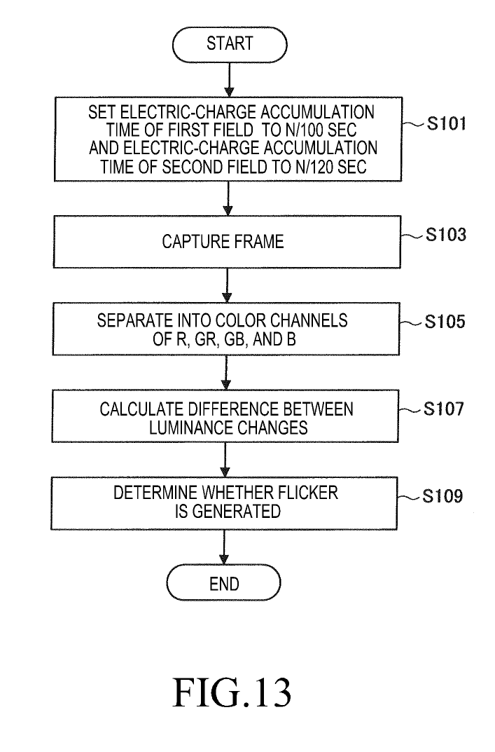

FIG. 13 is a flowchart illustrating an imaging method according to an embodiment of the present invention. Further, the method illustrated in FIG. 13 will be described below with reference to the imaging device 100 illustrated in FIG. 12, which captures a single-frame image and detects a flicker in the captured image.

Referring to FIG. 13, in step S101, the exposure controller 105 sets the first electric-charge accumulation time, which is the electric-charge accumulation time of the scanning lines included in the first field among the scanning lines of the imaging element 101, to n/100 sec and sets the second electric-charge accumulation time, which is the electric-charge accumulation time of the scanning lines included in the second field, to n/120 sec. As described above, n is a natural number.

When the flicker frequency is 100 Hz, the first electric-charge accumulation time (n/100 sec) is a natural-number multiple of the flicker period ( 1/100 sec) and is synchronized with the flicker period. When the flicker frequency is 120 Hz, the second electric-charge accumulation time (n/120 sec) is a natural-number multiple of the flicker period ( 1/120 sec) and is synchronized with the flicker period.

When the flicker frequency is f (Hz), the electric-charge accumulation time t (sec) synchronized with the flicker period is obtained using the natural number n from Equation (1) below.

t=n/f (1)

Herein, if the electric-charge accumulation time of the scanning lines included in the first field or the second field is changed by the exposure controller 105 for flicker detection, the exposure of the captured image is changed.

In accordance with an embodiment of the present invention, to compensate for the change in the exposure of the captured image, an amplification gain (sensitivity) used in the amplifier of the analog processor 102 is adjusted. For example, when an electric-charge accumulation time and a gain prior to the change for flicker detection are Tv and Sv, respectively, and an electric-charge accumulation time and a gain that are changed for flicker detection are Tv′ and Sv′, respectively, a relationship between Tv, Sv, Tv′, and Sv′ can be obtained from Equation (2). In addition, any one of Tv, Sv, Tv′, and Sv′ is a peak or an apex value.

Sv′=Sv+(Tv′−Tv′) (2)

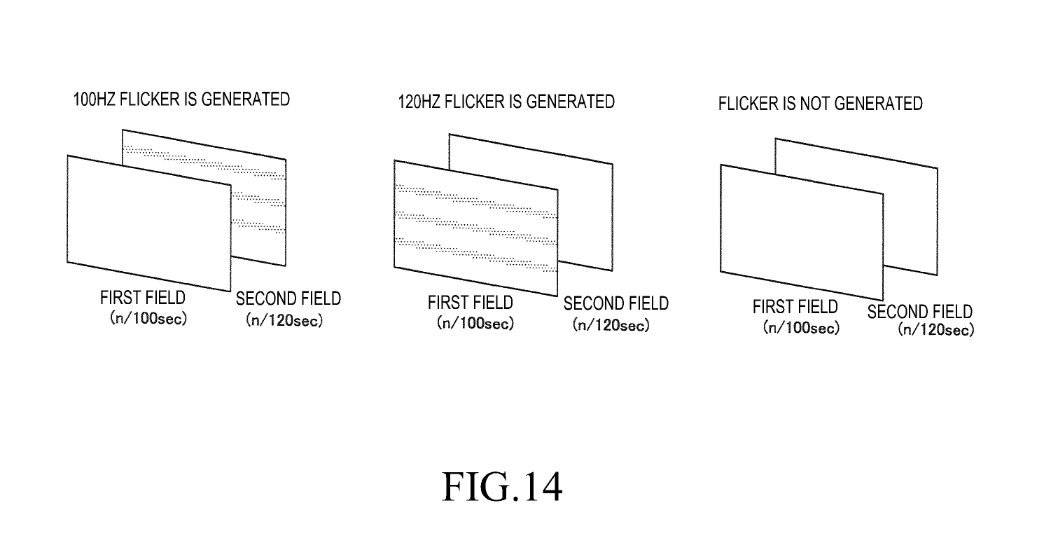

In step S103, the imaging element 101 is controlled by the timing generator 104, and each scanning line is exposed during a corresponding electric-charge accumulation time set by the exposure controller 105 in step S101, thus capturing a single-frame image. This operation will be described in more detail below with reference to FIG. 14.

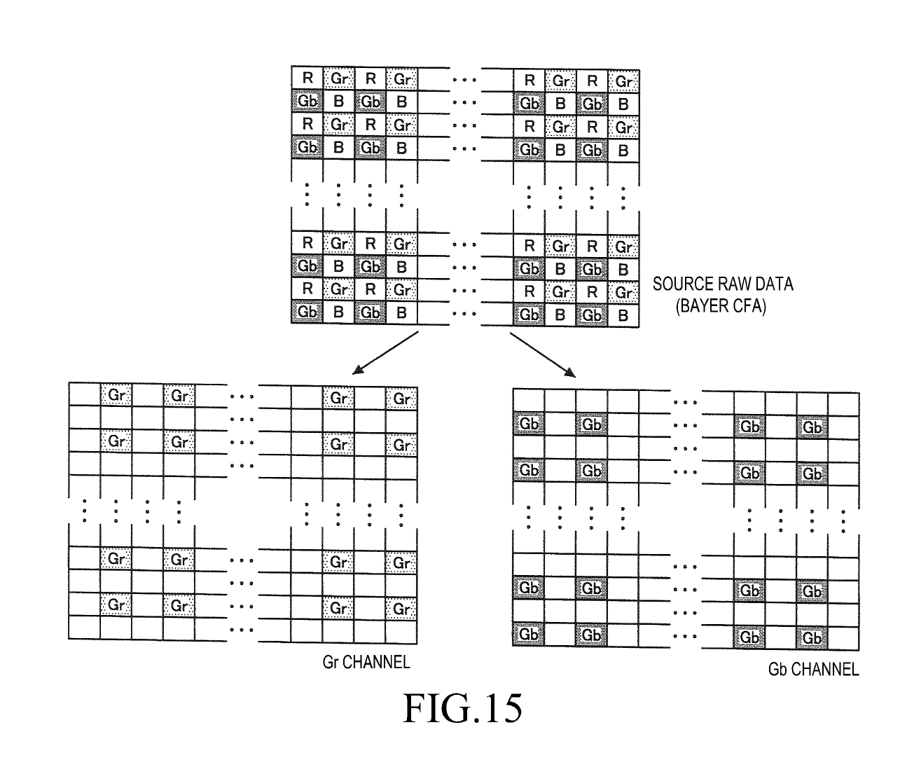

In step S105, the color channel separator 106 separates RAW data of the captured single-frame image into color channel information of R, Gr, Gb, and B (i.e., color channel pixel values). This operation will be described in more detail below with reference to FIG. 15.

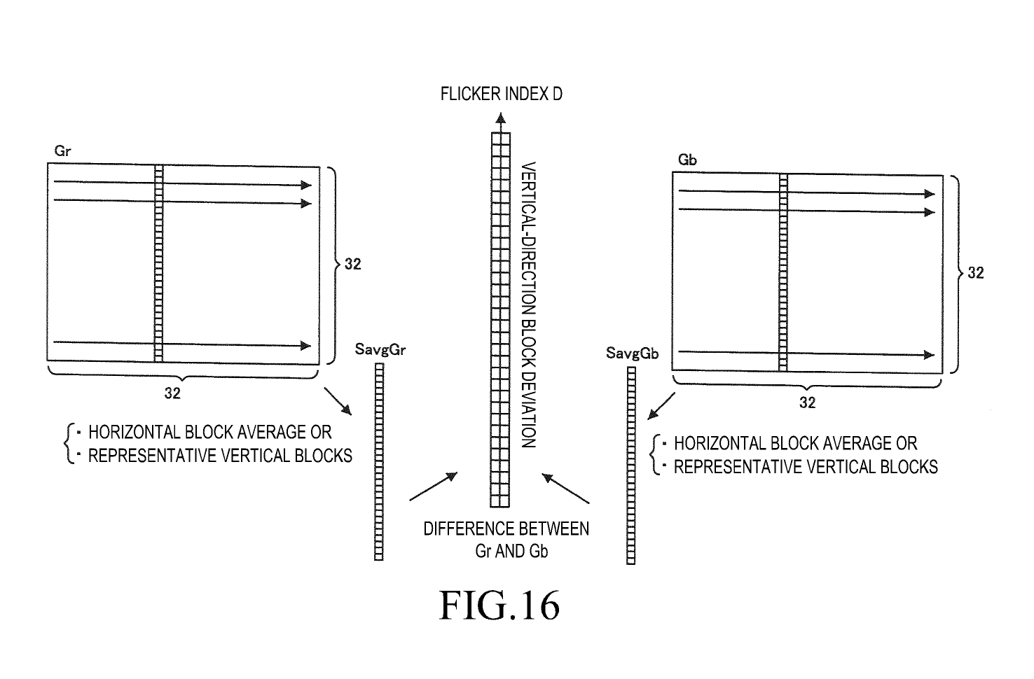

In step S107, the block luminance integrator 107 calculates a luminance integral value for each block included in the image and the luminance difference calculator 108 calculates a difference between vertical-direction changes (luminance changes) of the luminance integral value for each block. This operation will be described in more detail below with reference to FIG. 16.

In step S109, the flicker detector 109 determines whether flicker is generated or not, based on the differences between luminance changes calculated in step S107.

FIG. 14 illustrates flicker noise generated in accordance with an embodiment of the present invention.

Referring to FIG. 14, flicker noise is generated in an image due to a 100 Hz flicker, flicker noise is generated in an image due to a 120 Hz flicker, and no flicker noise is generated by a flicker.

When the flicker frequency is 100 Hz, in the first field, the electric-charge accumulation time (n/100 sec) is synchronized with the flicker period and no flicker noise is generated in the image. In the second field, the electric-charge accumulation time (n/120 sec) is not synchronized with the flicker period, such that flicker noise (line flicker) is generated in the image.

When the flicker frequency being 120 Hz, in the first field, the electric-charge accumulation time (n/100 sec) is not synchronized with the flicker period, such that flicker noise (line flicker) is generated in the image. In the second field, the electric-charge accumulation time (n/120 sec) is synchronized with the flicker period, such that no flicker noise is generated in the image.

In addition, for example, if there is no illuminance change of the object, i.e., there is no flicker, flicker noise is not generated in the image irrespective of an electric-charge accumulation time. Therefore, in this case, no flicker noise is generated in the image for either the first field or the second field.

FIG. 15 illustrates color channel separation in accordance with an embodiment of the present invention.

Referring to FIG. 15, color channel information of Gr and Gb is separated from source RAW data, which is generated based on a Bayer CFA and includes four color channel information of R, Gr, Gb, and B.

As described above, in the imaging element 101, Gr is a green pixel unit included in the first field and Gb is a green pixel unit included in the second field. Accordingly, luminances of the color channels Gr and Gb obtained from color channel information separation of the color channel separator 106 indicate luminances of images captured by the scanning lines of the first field and the second field. Thus, by analyzing the luminances of the separated color channels Gr and Gb, generation or non-generation of flicker noise in each of the first field and the second field can be determined. In addition, because a light-receiving sensitivity difference between the color channels Gr and Gb is small, the color channels Gr and Gb are used for analysis of the luminance difference.

FIG. 16 illustrates a calculation of a luminance change difference in accordance with an embodiment of the present invention.

Referring to FIG. 16, 1024 blocks (i.e., a group of some pixels forming an image) are set by dividing the image into 32 (vertical)×32 (horizontal) blocks, and a luminance integral value in the color channels Gr and Gb for each block is calculated. Similar processing may be executed pixel-by-pixel instead of block-by-block; however, the amount of computation is reduced by using a block unit.

For calculation of the luminance change difference, the block luminance integrator 107 calculates luminance integral values for 32 blocks corresponding to a column arranged in a longitudinal (vertical) direction of the screen. The luminance integral values of those blocks may be average values of luminance integral values of blocks arranged in a widthwise (horizontal) direction of the screen at the same vertical position, or blocks of an arbitrary column arranged in the vertical direction may be extracted as representative vertical blocks.

For example, if average values of luminance integral values of blocks arranged in the horizontal direction are used as luminance integral values of blocks corresponding to a column arranged in the vertical direction, a luminance integral value Savgᵥ of a block is obtained from Equation (3). In Equation (3), Sᵥₕ indicates a luminance integral value of a block located at a v^{th} position in the vertical direction and at an h^{th} position in the horizontal direction.

$${Savg}_{v} = \frac{{\sum }_{h = 1}^{32} {S}_{vh}}{32} \qquad ( 3 )$$

Luminance changes Savg (Savg₁ through Savg₃₂) of blocks corresponding to a column arranged in the vertical direction, which are calculated as described above, are generated with respect to a channel Gr (SavgGr) and a channel Gb (SavgGb), respectively.

The luminance difference calculator 108 calculates a flicker index D from the luminance difference between SavgGr and SavgGb. The flicker index D is obtained by integrating and averaging the luminance difference between SavgGr and SavgGb, using Equation (4). In Equation (4), k₁ and k₂ are coefficients for correcting a luminance difference that may be caused by a difference between electric-charge accumulation times of scanning lines (i.e., a difference between exposure times) of an image of the first field and an image of the second field.

$$D = \frac{{\sum }_{h = 1}^{32} \vert {k}_{1} \cdot {SavgGr}_{v} - {k}_{2} \cdot {SavgGb}_{v} \vert}{32} \qquad ( 4 )$$

As the flicker index D increases, flicker noise having a high amplitude is estimated to be generated in the image. The flicker index D may be obtained as a dispersion or deviation value of luminance differences.

As described above in reference to FIG. 13, the flicker detector 109 determines whether flicker is generated or not in step S109.

Again, a flicker frequency is 100 Hz or 120 Hz, and the electric-charge accumulation times of the scanning lines of the first field and the second field are n/100 sec and n/120 sec, respectively. Therefore, as described with reference to FIG. 14, flicker noise is generated or not generated in either the image of the first field corresponding to the channel Gr or the image of the second field corresponding to the channel Gb.

If the flicker noise is generated in either the image of the first field or the image of the second field, the luminance change in the image where the flicker noise is generated is large, whereas the luminance change in the image where the flicker noise is not generated is small. Accordingly, when the flicker noise is generated in one of the images, a relatively large difference is generated between the luminance changes of the images and the flicker index D, which is an integral value of the luminance change difference. is relatively large.

The flicker index D calculated by the luminance difference calculator 108 and generation of the flicker noise have a relationship shown below in Table 2.

TABLE 2

| | First Field | Second Field | Flicker Index |
|---|---|---|---|
| | (Gr Channel) | (Gb Channel) | (D = \|Gr − Gb\|) |
| 100 Hz Flicker | Generation of | Non-Generation | >Threshold |
| | Flicker Noise | of Flicker Noise | (Flicker |
| | | | Component) |
| 120 Hz Flicker | Non-Generation | Generation of | >Threshold |
| | of Flicker Noise | Flicker Noise | (Flicker |
| | | | Component) |
| Non- | Non-Generation | Non-Generation | ≈0 |
| Generation | of Flicker Noise | of Flicker Noise | |
| of Flicker | | | |

Herein, the flicker detector 109 compares the flicker index D with a predetermined threshold to determine whether flicker is generated. For example, if Equation (5) is satisfied, the flicker detector 109 determines that flicker noise is generated in the image. The threshold is a design value adjusted according to brightness or the like.

D≧Threshold (5)

The flicker detector 109 additionally counts a peak of a luminance change difference extracted as a flicker component or specifies a frequency through Fourier transform, thereby specifying the frequency of the flicker.

In flicker detection processing according to the above-described embodiments of the present invention, flicker can be detected using a single-frame image. Therefore, even when image shake occurs between frames, for example, while photographing a moving object, the precision of flicker detection does not degrade. In addition, because a plurality of frame images are not obtained, high-speed flicker detection is provided.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. An imaging device comprising:
an exposure controller for setting a first electric-charge accumulation time for a first scanning line of an imaging element, and for setting a second electric-charge accumulation time for a second scanning line of the imaging element;
a luminance difference calculator for calculating a luminance difference in a vertical direction between a first image signal based on the first scanning line and a second image signal based on the second scanning line from a frame output from the imaging element, the vertical direction being perpendicular to a direction of the scanning lines; and
a flicker detector for determining whether flicker is generated in the frame based on the luminance difference.

2. The imaging device of claim 1, wherein one of the first electric-charge accumulation time and the second electric-charge accumulation time is a natural-number multiple of a period of the flicker.

3. The imaging device of claim 1, wherein the exposure controller alternately sets the first electric-charge accumulation time and the second electric-charge accumulation time for at least four consecutive scanning lines of the imaging element.

4. The imaging device of claim 1, wherein the flicker detector compares the luminance difference with a preset threshold to determine whether the flicker is generated.

5. The imaging device of claim 1, further comprising a block luminance integrator for obtaining luminance integral values of the first image signal and the second image signal in each of a plurality of blocks obtained by dividing the frame,
wherein the luminance difference calculator calculates the luminance difference based on each of the plurality of blocks.

6. The imaging device of claim 5, wherein the luminance difference calculator calculates a luminance difference between the first image signal and the second image signal for each of reference column blocks among the plurality of blocks which are arranged in the vertical direction, and calculates a flicker index by integrating and averaging the calculated luminance differences of each of the reference column blocks, and
wherein the flicker detector compares the flicker index with a preset threshold to determine whether the flicker is generated.

7. The imaging device of claim 1, further comprising an analog processor for setting different amplification gains for the first image signal and the second image signal to compensate for the luminance difference caused by a difference between the first electric-charge accumulation time of the first image signal and the second electric-charge accumulation time of the second image signal.

8. The imaging device of claim 1, wherein the flicker detector specifies a frequency of the flicker based on a frequency analysis of the luminance difference.

9. An imaging method of an imaging device, the method comprising:
setting a first electric-charge accumulation time for a first scanning line of an imaging element;
setting a second electric-charge accumulation time for a second scanning line of the imaging element;
calculating a luminance difference in a vertical direction between a first image signal based on the first scanning line and a second image signal based on the second scanning line of a frame output from the imaging element, the vertical direction being perpendicular to a direction of the scanning lines; and
determining whether flicker is generated in the frame based on the luminance difference.

10. The imaging method of claim 9, wherein one of the first electric-charge accumulation time and the second electric-charge accumulation time is a natural-number multiple of a period of the flicker.

11. The imaging method of claim 9, wherein the exposure controller alternately sets the first electric-charge accumulation time and the second electric-charge accumulation time for at least four consecutive scanning lines of the imaging element.

12. The imaging method of claim 9, further comprising calculating luminance integral values of the first image signal and the second image signal in each of a plurality of blocks obtained by dividing the frame,
wherein the luminance difference is calculated based on each of the plurality of blocks.

13. The imaging method of claim 9, wherein calculating the luminance difference comprises:
calculating a luminance difference between the first image signal and the second image signal for each of reference column blocks among the plurality of blocks which are arranged in the vertical direction; and
calculating a flicker index by integrating and averaging the calculated luminance differences of the reference column blocks.

14. The imaging method of claim 13, wherein determining whether the flicker is generated comprises:
comparing the flicker index with a preset threshold; and
determining that the flicker is generated, when the flicker index is greater than the preset threshold.

15. The imaging method of claim 9, further comprising specifying a frequency of the flicker based on a frequency analysis of the luminance difference.
